(19) United States
(12) Patent Application Publication
(10) Pub. No.: US 2014/0209521 A1
(43) Pub. Date: Jul. 31, 2014

(54) SIDE FILTER OZONE WATER TREATMENT APPARATUS

(71) Applicant: Charles E.C. Harris, Chiang Rai (TH)

(72) Inventor: Charles E.C. Harris, Chiang Rai (TH)

(21) Appl. No.: 14/070,068

(22) Filed: Nov. 1, 2013

Related U.S. Application Data
(63) Continuation-in-part of application No. 13/925,391, filed on Jun. 24, 2013, now Pat. No. 8,753,523.
Application No. 13/925,391 is a division of application No. 12/686,315, filed on Jan. 12, 2010, now Pat. No. 8,470,170.
(60) Provisional application No. 61/721,423, filed on Nov. 1, 2012.
(60) Provisional application No. 61/144,093, filed on Jan. 12, 2009.

(51) Int. Cl. E04H 4/12; C02F 1/78

(52) U.S. Cl. CPC E04H 4/1281; C02F 1/78
USPC 210/127; 210/151

(57) ABSTRACT

A system for treating fluid in a pool, spa, or other main fluid reservoir includes a side-filter tank located next to the main fluid reservoir. An ozone generator pumps a mixture of ozone and air into a lift tube containing fluid from the main fluid reservoir. The fluid flows through the lift tube due to the effect of ozonated air bubbles released by a diffuser at the bottom of the lift tube. Fluid is piped from the main fluid reservoir to the side-filter tank and lift tube and back into the main fluid reservoir. The fluid is caused to pass through the side-filter tank and back into the main reservoir as a result of the flow of ozonated air in the lift tube without the use of any fluid pump.

### PRIORITY

The present application is a continuation-in-part of, and claims priority to co-pending U.S. patent application Ser. No. 13/925,391, filed Jun. 24, 2013, the entirety of which is hereby incorporated herein by reference. The present application also claims priority to U.S. Provisional Patent Application Ser. No. 61/721,423, filed Nov. 1, 2013, entitled Side-Filter Ozone Water Treatment System, the entirety of which is hereby incorporated herein by reference. The present application also claims priority to U.S. patent application Ser. No. 12/686,315, filed Jan. 12, 2010, now U.S. Pat. No. 8,470,170 and U.S. Provisional Patent Application Ser. No. 61/144,093, filed Jan. 12, 2009.

### FIELD OF THE INVENTION

This invention relates in general to fluid treatment methods, and more specifically to apparatus for treating fluid from a fluid reservoir by injecting ozonated air into a lift tube containing fluid from the fluid reservoir.

### BACKGROUND

Ozone water treatment systems have been in use for over 100 years in many applications including the pool and spa industry as well as treating water in water storage tanks. Ozone is used in combination with various chemicals in the pool and spa industry. Ozone is also used to treat iron, manganese, and hydrogen sulfide in well water and to kill pathogens in surface waters such as lakes and streams. Ozone systems come in many varieties and ozone is produced in many ways known in the art.

Ozone water treatment systems for water storage tanks are designed to clean “raw” water, e.g., well water, whereas systems for pools and spas are designed to keep treated water clean as it is used over and over again. Prior art systems focus on using ozone and a filter to treat a reservoir of water. One prior art system teaches a water purification apparatus suspended inside a water tank. The apparatus includes a filter for filtering the water and a lift tube to add ozone to the water in the reservoir. Such a prior art system is disclosed in U.S. Pat. No. 5,190,648 to Ramsauer, issued Mar. 2, 1993.

In the Ramsauer system, air containing ozone generated by the ozone generator is injected into the bottom of the lift tube using a diffuser, which causes the ozonated air to be converted to bubbles. The ozonated air bubbles up through the water in the lift tube and into the water tank. Excess ozonated air escapes through the top of the tank. As taught in Ramsauer, the lift tube is part of an in-the-tank filter module. The ozone gas mixing and filtration and circulation of the water are accomplished within the filter module assembly. The action of the bubbles rising and expanding in the lift tube causes a current flow, which causes the water to be drawn through the filter where the water is filtered with each pass and thereby to prefilter the water prior to its contact with the ozonated air. This increases the effectiveness of the ozone in treating the water.

Prior art ozone water treatment systems are generally simple to install in the fluid reservoir and require no cutting into the wall of the pool, spa, or tank to install separate lines. However, such a “single” reservoir fluid treatment system is more difficult to maintain, because the filter needs to be pulled from the reservoir for cleaning and maintenance. In addition, the Ramsauer system, for example, does not treat the ozonated air emanating from the reservoir after treatment, for destruction or to channel it elsewhere for some other use. There is no mechanism for preventing the user from being exposed (when used in pools and spas) to the damaging effects of ozone on an individual's mucus membranes, eyes, and skin.

### SUMMARY OF THE INVENTION

The present invention solves the limitations of prior art ozone fluid treatment systems.

In one embodiment, a fluid filter is installed in an auxiliary fluid tank or reservoir that is positioned to the side of a main fluid reservoir, whether it be a pool, spa, or water tank. This auxiliary fluid reservoir is alternatively referred to as a “side filter” or “Sifer” reservoir or tank. A lift tube lifts fluid received from the main reservoir, after the fluid has been filtered in the Sifer tank, causing the fluid to flow into a second reservoir also positioned to the side of the main reservoir. The flow of fluid through the lift tube increases the height of the fluid level in the second reservoir above the fluid level of the main fluid reservoir and this difference in fluid level creates a gravity flow of fluid from the second reservoir back to the main reservoir. This circular flow allows the filter to trap impurities in the fluid while the ozonated air treats the fluid in the lift tube. After fluid treatment, the ozonated air may be captured and either destroyed or channeled to another location.

The side filter tank enables the easy cleaning of the filter in a manner such that the impurities captured by the filter are kept out of the main fluid reservoir. The auxiliary fluid reservoir also enables a conduit to feed fluid from an external source to the auxiliary fluid reservoir. It may be possible to even clean the filter while it is still in the side filter tank, by washing it and letting the particulates drain out the bottom. Moreover, for pools and spas, the side filter tank allows an ozone generator and ozonated air it produces to operate 24 hours a day at a comfortable distance from persons using the pool or spa who would otherwise be irritated by the ozone.

In another embodiment, a single auxiliary fluid reservoir is used to both filter and ozone treat the fluid before sending the treated fluid to the main fluid reservoir. This gives the filter an initial opportunity to remove impurities before the new fluid flows to the main reservoir.

Other embodiments are as shown in the figures.

According to one embodiment, the present invention is an apparatus for ozone-aerating and filtering fluid in a main fluid reservoir, comprising: an auxiliary fluid reservoir positioned adjacent to and outside of the main fluid reservoir; a lift tube positioned outside of the main fluid reservoir and having an upper end and a lower end, said lift tube upper end open within the auxiliary fluid reservoir, said lift tube extending below the auxiliary fluid reservoir a predetermined length; a first conduit for enabling fluid in the auxiliary fluid reservoir to flow into the main fluid reservoir; a second conduit for enabling fluid to flow by gravity from the main fluid reservoir into the lower end of said lift tube; a diffuser positioned inside said lift tube at its lower end for injecting ozonated air into the fluid in said lift tube, such that, when ozonated air is injected into said lift tube by the diffuser, the ozonated air comes into contact with the fluid in said lift tube and ozone-aerates said fluid, and wherein the expansion of the ozonated air as it bubbles up said lift tube causes fluid in said lift tube to flow up said lift tube and into the auxiliary fluid reservoir, which causes the level of fluid in the auxiliary fluid reservoir to rise higher than the level of fluid in the main fluid reservoir, and thereby cause ozone-aerated fluid in the auxiliary fluid reservoir to flow by gravity into the first fluid conduit and into the main fluid reservoir at the same time causing fluid to be drawn through said second fluid conduit from the main fluid reservoir and into said lift tube; and a fluid filter positioned outside of the main reservoir and in the fluid path formed by said first and second fluid conduits, said lift tube, and said auxiliary fluid reservoir for filtering the fluid flowing therein.

According to another embodiment, the present invention is an apparatus for ozone-aerating and filtering fluid in a main fluid reservoir, comprising: an auxiliary fluid reservoir positioned adjacent to and outside of the main fluid reservoir; a first conduit for enabling fluid to flow by gravity from the main fluid reservoir into the auxiliary fluid reservoir; a fluid filter housed within the auxiliary fluid reservoir; a lift tube having an upper end and a lower end, the upper end of said lift tube open within the main fluid reservoir, said lift tube extending below the main fluid reservoir a predetermined length; a second conduit for enabling fluid to flow by gravity from the auxiliary fluid reservoir into the lower end of said lift tube; and a diffuser positioned inside said lift tube at its lower end for injecting ozonated air into the fluid in said lift tube, such that, when ozonated air is injected into said lift tube by the diffuser, the ozonated air comes into contact with the fluid in said lift tube and ozone-aerates said fluid, and wherein the expansion of the ozonated air as it bubbles up said lift tube causes the fluid in said lift tube to flow up said lift tube and into the main fluid reservoir, such that fluid is caused to flow by gravity into and through the first fluid conduit from the main fluid reservoir into the auxiliary fluid reservoir, through said filter, into and through said second fluid conduit, and into the lower end of said lift tube.

### BRIEF DESCRIPTION OF THE DRAWINGS

The accompanying drawings, which are incorporated in and constitute a part of this specification, exemplify embodiments of the present invention and, together with the description, serve to explain and illustrate principles of the invention and not to limit the claimed invention thereto. The drawings are intended to illustrate major features of the exemplary embodiments in a diagrammatic manner. The drawings are not intended to depict every feature of actual embodiments nor relative dimensions of the depicted elements, and are not drawn to scale. Note also that reference symbols or names are used in the Figures to indicate certain aspects or features shown therein, with reference symbols common to more than one Figure indicating like components, aspects or features shown therein.

FIG. 1 illustrates a ground level side filter ozone water treatment system for a fluid reservoir according to one embodiment of the present invention.

FIG. 2 illustrates a ground level side filter ozone water treatment system for a fluid reservoir comprising multiple fluid storage tanks according to one embodiment of the present invention.

FIG. 3 illustrates a raised side filter ozone water treatment system for a water reservoir comprising multiple fluid storage tanks according to one embodiment of the present invention.

FIG. 4 illustrates a ground level side filter ozone water treatment system for a water reservoir with the lift tube upper end positioned inside the water reservoir according to one embodiment of the present invention.

FIG. 5 illustrates a ground level side filter ozone water treatment system for a water reservoir with the lift tube upper end positioned inside the water reservoir according to one embodiment of the present invention.

FIG. 6 illustrates a ground level side filter ozone water treatment system for a fluid reservoir comprising multiple fluid storage tanks with the lift tube upper end positioned inside one of the water tanks according to one embodiment of the present invention.

FIG. 7 illustrates a side-filter ozone water treatment system for a fluid reservoir comprising multiple fluid storage tanks mounted on the roof of a building or the like according to one embodiment of the present invention.

FIG. 8 is an exemplary filter cartridge for use as a fluid filter according to one embodiment of the present invention.

FIG. 9 is a graph of an exemplary air pump pressure flow curve.

### DETAILED DESCRIPTION

In one embodiment of the invention, an ozone generator pumps a mixture of ozone and air into a diffuser positioned at the bottom of a lift tube filled with a liquid, to generate bubbles in the fluid that travel up the lift tube. These bubbles create an upward flow in the fluid contained in the lift tube. The flow of fluid in the lift tube causes the fluid to flow through a filter without the use of any conventional fluid pump. The fluid flows past the filter solely due to the effect of ozonated air bubbles released inside the lift tube. The upper end of the lift tube is positioned in either an auxiliary reservoir or the main fluid reservoir. As a result, a gentle, more controlled flow of ozonated fluid can be provided to a pool, spa, or storage tank, which can create a more desirable experience for a user of the pool, spa, or storage tank, compared to a system where a conventional fluid pump is used to supply ozonated fluid. The level of ozone in the treated fluid can be controlled by various system parameters, including, but not limited to, ozone generation rate, ratio of air and ozone in the mixture that is released in the fluid by the diffuser, the dimensions of the auxiliary reservoir and the main reservoir, the dimensions of the lift tube, etc.

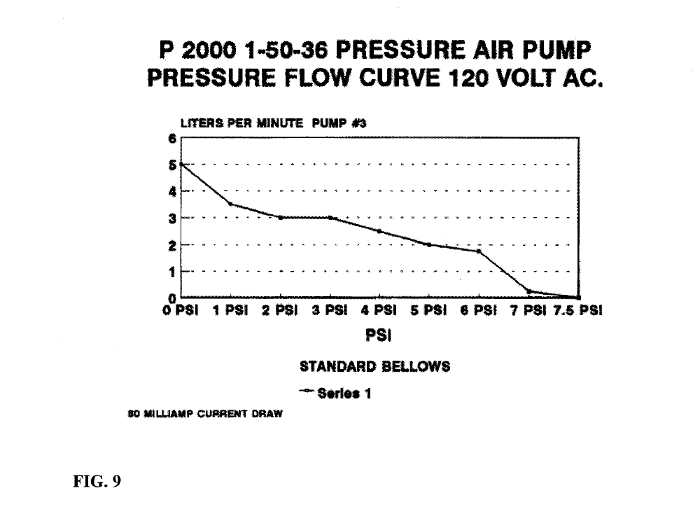

A key aspect of each of the embodiments of the present invention described herein is that the lift tube length is not limited by the depth of the reservoir containing the fluid to be treated. The present invention enables the efficient use of the aeration ozone technology by allowing the diffuser stone to be positioned preferably at about 3.5 meters below the surface of the water in the main fluid reservoir, regardless of whether the pool, spa or tank is deep or shallow (or a storage tank is tall or short), by the use of a lift tube whose lower end can be at a lower level than the bottom of a given storage tank. In other words, the deeper the diffuser stone, the more ozone dissolves into the water. In many parts of the world, many pools, spas, surge tanks, and storage tanks are only one meter high. Placing a diffuser stone at a depth of only one meter reduces the time allowed for ozone and oxygen to dissolve into the water. As can be seen in the graph shown in FIG. 9, a reasonable operating pressure versus flow of air from the air pump is about 3 to 4 psi, which works out to a depth of approximately 3 to 4 meters in water.

FIG. 9 is a graph of typical air pump used in the USA (110 v and 60 hz) for the Sifer system.

Data: http://www.emmcoinc.com/images/p2000-1-50-36chart.pdf

The deeper the diffuser stone, the longer the bubbles dissolve oxygen and ozone into the water as the bubbles take time to rise to the surface. On the other hand, the deeper the diffuser stone, the greater the pressure that is required to release bubbles. And, for a given ozone generator air pump, the increase in pressure results in a decrease in air flow and a resulting decrease in the circulation flow of water through the treatment system.

Although water is the preferred fluid to be treated according to the present invention, persons skilled in the art will appreciate that the same apparatus can be used for treating other fluids (the term “fluid” encompasses both liquid and gas and a liquid/gas mixture) without diverting from the scope of the invention. Similarly, the term “reservoir” encompasses spas, pools, storage tanks, treatment/filter tanks, etc. Additionally, the term “ozonated air” or “ozone-treated air” are synonymous, meaning a volume of air and ozone gas mixed together.

Ozone in high concentrations destroys pathogens, spores, algae and various germs and it also oxidizes a number of impurities such as iron, manganese, oils and organic wastes. According to the present invention, a high volume of treated air is pumped into the fluid along with a relatively low concentration of ozone. Ozone in low concentrations may not kill all pathogens. However, ozonated fluid helps to hinder the growth of many bacteria and may reduce pH fluctuations by, for example, obstructing the nitrogen cycle. The relatively gentle fluid flow past the filter also helps to keep the fluid clean too, because many impurities that would normally be pushed through a filter as a result of the force applied by a conventional fluid pump to the fluid are instead trapped by the ozone aeration and filtration apparatus according to the present invention. The advantage of using an ozone aeration system according to the present invention is that it renders the fluid in the pool, spa, or tank rather inhospitable as a growth medium; i.e., bacteria and algae that might otherwise flourish in another environment seem to be greatly reduced because of the lack of nutrients and other conditions needed for growth and reproduction. While the lift tube and side filter tank may contain fluid that has detectable levels of dissolved ozone in the fluid, it is not certain that the minimum recommended detectable levels of ozone required for disinfection (0.05 ppm) would be present. However, the low level of ozone concentration may add other benefits to the aeration and filtration system by allowing the filter media itself to form a bio-film composed of protozoa, bacteria, algae, and other living organisms that act as a kind of bio-filter itself with its own “ecosystem” which at the time the water passes through the bio-film, consumes and traps many impurities which would otherwise contaminate the pool, spa, or water tank and create conditions in the pool, spa, or water tank fostering the growth of bacteria, algae, and other impurities as well as chemical conditions which might make the water unusable for humans, for example variations in the nitrogen cycle (making ammonia) and volatile fluctuations in the acid/base pH of the water. A very high level of ozone and the use of chemicals such as chlorine, bromine, or salt (which is used to make chlorine), as used in conventional water treatment systems, may hinder the formation of such a biofilm on the filter media, or destroy the biofilm if it is already formed.

The concept of using a biofilm for water treatment is not new. However, the inventor is not aware of its use for pools and spas. Normally, the idea comes from its use with slow sand filters which form a gelatinous layer called a Schmutzdecke (a grime or filth cover in German coined by the scientist who discovered its significance for water treatment) in the top few millimeters of the sand layer. The Schmutzdecke consists of bacteria, fungi, protozoa, worms, and a range of aquatic life. The Schmutzdecke is the layer that provides the effective treatment in potable water treatment using the sand as the underlying support medium for this biological treatment layer. As water passes through the Schmutzdecke, particles of foreign matter are trapped in the layer and dissolved organic material is adsorbed and metabolized by the bacteria, fungi and protozoa. In the present invention, the filter media, such as a Reemay media, provides the support for the Schmutzdecke as it adsorbs and metabolizes the dissolved and suspended organic materials in the main fluid reservoir. The formation of a Schmutzdecke on the fluid filter is only made possible by the combination of the gentle 24 hour filtration and ozone/aeration, and the low concentration of ozone and treated purified air that can keep a pool, spa, or water tank exceptionally clean. So clean, in fact, that the use of chemicals are greatly reduced or eliminated entirely.

It should be noted that the ozone fluid treatment embodiments disclosed in the present application are configured to work in tandem with traditional fluid pump and filter systems that are commonly employed. These traditional pumps and filters are separate from the ozone system and use separate fluid lines (although for the sake of convenience, both systems could share the same outflow and inflow lines for existing structures). The reason to add the ozone fluid treatment to a pool, spa, or water storage tank is that it greatly reduces or entirely eliminates the need for chlorine, chemicals, salts, clarifiers, Ph stabilizers, or other additives that are normally used to keep a pool or spa clean.

A related patent application Ser. No. 12/634,652, by the same inventor, titled, “Ozone Generator Apparatus and Method for Purification of Air or Liquids,” filed Dec. 9, 2009, discloses a unique ozone generator which provides significant improvements to existing pool, spa, and fluid storage tank ozone fluid treatment systems. This application is incorporated herein in its entirety by reference.

For pools, spas, and water storage tanks, the ozone generator described in application Ser. No. 12/634,652, preferably is the “double UV and double air pump system” which operates continuously 24 hours a day and produces about 6-10 grams of ozone in the same time period. It also produces about 10,000 liters of treated air per 24 hours. Ozone is produced by pumping filtered and heated ambient air past special ozone producing UV lamps housed in a sealed chamber. The treated air is pumped through the ozone lamp housing at the rate of about 7 liters per minute at an average pressure of 3 psi. Ozone makes up less that 1% of the total output (most UV ozone generators produce ozone on the order of 0.1 to 0.01% by weight of air fed to the generator)—the other 99% of the gas stream is treated air which is relatively free of pathogens, germs, algae spores, dust, and other impurities. This mixture of air and ozone gas is pumped to a diffuser which is inside a lift tube filled with water. The diffuser releases thousands of tiny bubbles which cause the water to rise and cause a flow of water through a filter. As ozone can be made from many different devices (such as a corona discharge “CD” system), any combination gas comprising ozone and clean treated air delivered at approximately 7 liters per minute at 3 psi in the ratio of about 1% ozone (i.e., similar in output to the UV system described herein) to 99% air with ozone being produced on a continuous basis in 24 hours in a total amount of approximately 6-10 grams can be used in the ozone water treatment systems hereinafter described below. As far as the ozone output on a 24 hour basis for use in pools and spas, the main consideration would be the comfort of the users, as too high an ozone concentration would be irritating to the eyes and skin, and might inhibit the benefits of maintaining a biofilm filter on the fluid filter itself. On the other hand, users who did not observe proper hygiene, or who used lavish amounts of sun tan oils, or who required a pool or spa that was quite large or not covered, might need an ozone generator with a higher output than the preferred apparatus mentioned here.

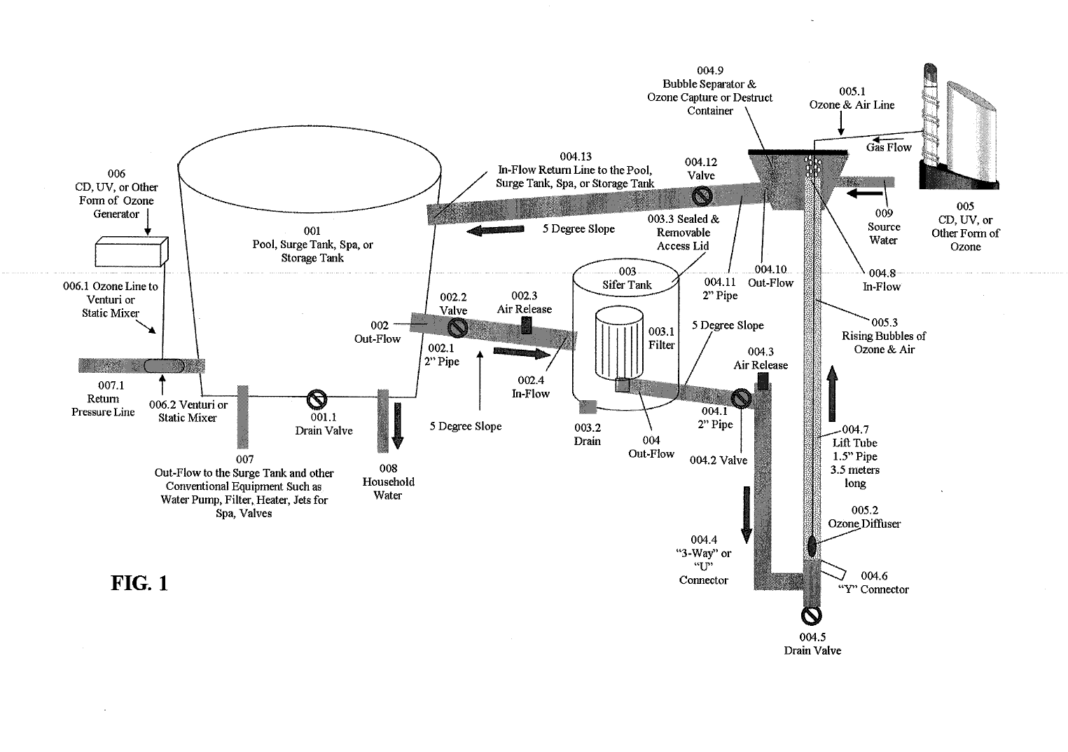

Referring now to FIG. 1, shown in this figure is a ground level side filter ozone water treatment system for a fluid reservoir according to one embodiment of the present invention. As seen in FIG. 1, fluid from a pool, spa, or storage tank 001 flows through an out-flow opening 002 and into an out-flow pipe 002.1 at the bottom (or near the bottom) of the pool or spa. Out-flow pipe 002.1 is preferably 2 inches in diameter. The fluid flows down preferably through the 2 inch pipe 002.1 with a slope of at least 5 degrees downwards to allow trapped air in the out-flow pipe to rise to the surface of the pool or spa. The out-flow pipe has an on-off fluid flow control valve 002.2 and an air release valve 002.3.

In the present embodiment and in many of the other embodiments disclosed in the present application, the depicted fluid pipes have a 5 degree slope. The slope is intended to prevent air from getting trapped in the fluid line. Trapped air acts like a valve which restricts or prevents the water from flowing. It may not be necessary for a given fluid pipe to have a slope, especially where there is also an air release valve in the pipe. Nevertheless, the slope is useful for preventing unwanted trapping of air.

The fluid in out-flow pipe 002.1 flows into a side filter tank 003 at inflow 002.4 and through a filter 003.1. Filter 003.1 preferably includes a filter media comprising folds of continuous filament spun-bonded polyester called Reemay® because of its high efficiency and large surface area. However, other conventional filter media may be used, such as polypropylene fibers, and sand, or diatomaceous earth filters may be used. Side filter tank 003 includes a removable access lid 003.3 and a drain valve 003.2 for enabling tank 003 and filter 003.1 to be periodically drained and cleaned. In the present embodiment, the side fill tank 003 could be any size. The tank 003 only needs to be large enough to fit the filter 003.1 and to have some additional space around the filter for cleaning.

Fluid flows out of side filter tank 003 at out-flow 004 and into a pipe 004.1. Pipe 004.1 is also preferable 2 inches in diameter. Pipe 004.1 includes an on-off fluid flow control valve 004.2. In conjunction with valve 002.2 and drain valve 003.2, valve 004.2 acts to prevent fluid from contaminating the main fluid reservoir 001 during cleaning or removal of filter 003.1.

The fluid in pipe 004.1 goes down preferably at least several feet and the fluid then is directed upwards by either a 3-way connector pipe or U pipe connector 004.4. Pipe 004.4 includes an air release valve 004.3 to clear air from pipe 004.4, as needed, and a drain valve 004.5 for maintenance purposes. Attached to the other end of U pipe 004.4 is a lift tube 004.7 into which the fluid from U pipe 004.4 flows. In lift tube 004.7, the fluid comes in contact with bubbles of ozone gas and air (so-called ozonated air) produced by an ozone diffuser 005.2. The ozonated air is produced by an ozone generator 005 which pumps pressurized ozone and air into an ozone line 005.1 that connects to ozone diffuser 003.2. Ozone generator 005 can be a CD, UV, or other form of ozone generator known in the art.

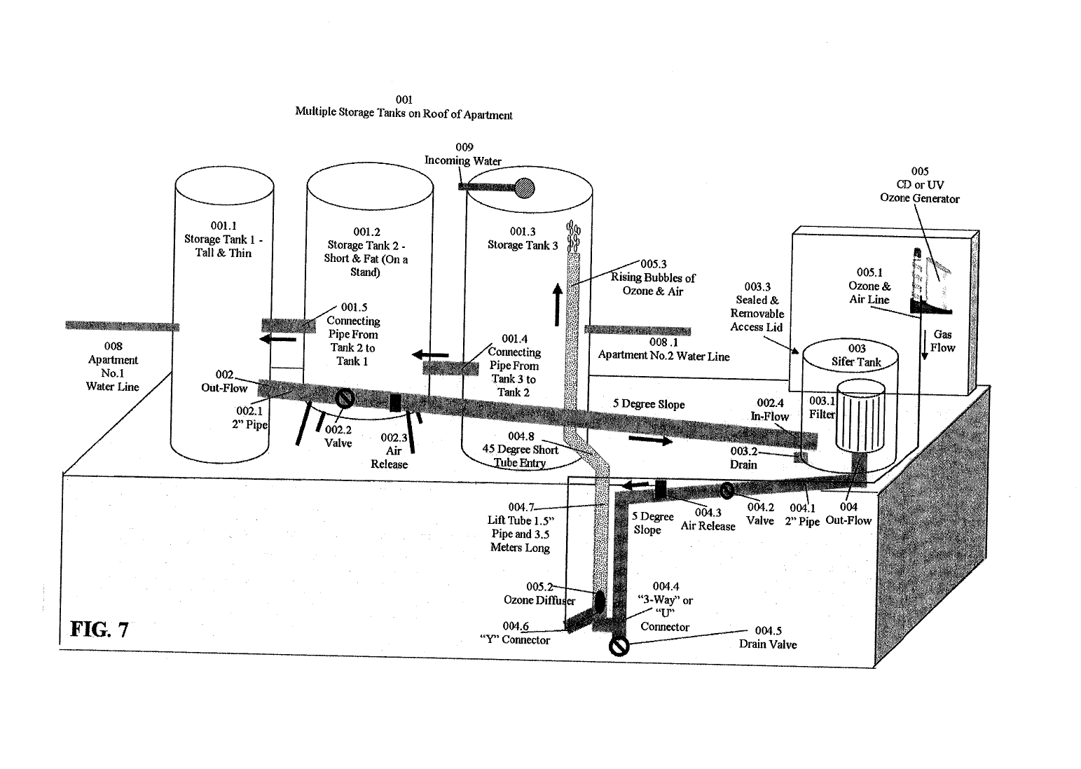

Diffuser 005.2 is positioned at the lower end of lift tube 004.7. The diffuser stone and out-flow end of the ozone and air line 005.1 can be positioned in lift tube 004.7 by either being lowered down into the lift tube from the top of the lift tube or positioned in the lift tube through a Y connector 004.6. Normally a Y connector would not be practical because the lift tube in many cases may be buried at least several feet into the ground. In such a case, it would be more convenient to lower the diffuser directly down into the top of the lift tube, as is illustrated in FIG. 1. However, in some situations, for example if the main fluid reservoir comprised a plurality of storage tanks located on the top of a building, as seen in FIG. 7, and the lift tube is attached to the side of the building, it may be very convenient to connect the ozone line through a Y connector at the bottom of the lift tube. In addition, one has to periodically clean the diffuser stone, and to do so, it needs to be removed from the lift tube and soaked in Muriatic acid in the case of dissolving iron or manganese that clogs it over time. This is another reason for inserting and removing the diffuser via the top of the lift tube in most configurations, rather than through a Y connector 004.6.

The diffuser 003.2 releases the ozonated air into the fluid in lift tube 004.7 in the form of small bubbles 005.3. Lift tube 004.7 preferable has a diameter of 1.5 to 2 inches and a length of about 10 feet (3.5 meters). The lift tube 004.7 preferably points straight up to prevent the ozonated air bubbles from coalescing. The rising bubbles 005.3 from the air/ozone mixture pull the fluid upwards inside the lift tube 004.7. In general, the longer the lift tube the better, as it provides more contact time to allow the ozone to both dissolve in the fluid and produce more lift of the fluid and a higher fluid flow rate. As noted above, a limiting factor on the length of the lift tube is the ability of the diffuser to emit bubbles, since the fluid pressure exerted on the diffuser increases as the lift tube's length is increased.

The lift tube 004.7 is open within auxiliary fluid reservoir 004.9. The lift tube lifts the fluid into an auxiliary fluid reservoir 004.9 at in-flow 004.8. The auxiliary fluid reservoir 004.9 should be located adjacent to the main fluid reservoir 001 preferably about 3 feet away to provide some distance between the main fluid reservoir, when it is a pool or spa, and the area where the ozone dissipates in the air. The auxiliary reservoir 004.9 may be fitted with a screen or semi-sealed top to prevent insects, birds, leaves, dust, etc. from falling into the fluid and/or to capture the ozone for later use or conversion back to simple oxygen. The auxiliary reservoir 004.9 should be preferably sized to hold about 30 to 50 gallons and be at a level so that the upper rim of the auxiliary reservoir is preferably about 12 inches above the fluid level of the main fluid reservoir 001. The bottom of auxiliary reservoir 004.9 is preferably about 20 inches below the surface of the fluid in the main fluid reservoir. When the main fluid reservoir 001 is empty, all the fluid from the auxiliary reservoir 004.9 should be able to easily drain back to the main fluid reservoir 001.

The lift tube 004.7 upper end should be positioned at such a level as to be no higher than the fluid level of the main fluid reservoir 001. A higher entry point might still be functional in certain situations, but the flow rate of the fluid in the lift tube would decrease until at some point as the top of the lift tube is raised higher and higher above the fluid level of the main fluid reservoir 001, the lift from the rising bubbles would not be great enough to pull the fluid up and out of the lift tube upper end at the in-flow level 004.8.

The fluid with dissolved ozone and air in auxiliary reservoir 004.9 flows back to the main fluid reservoir 001 through an out-flow 004.10 and into a 2 inch pipe 004.11 is positioned to have a downward slope preferably of at least 5 degrees (to let trapped air escape and for easy maintenance). The pipe 004.11 is also fitted with an on-off fluid flow control valve 004.12. Pipe 004.11 connects back to the main fluid reservoir at in-flow 00413. The location of the out-flow 002 and in-flow 004.13 can be adjusted (i.e., positioned as far apart as practical) so that there is maximum water flow and circulation of the entire contents of the main fluid reservoir.

The fluid path for fluid in the ozone water treatment system shown in FIG. 1 is therefore from the main fluid reservoir through filter 003.1, up the lift tube 004.7 and into the auxiliary fluid reservoir and from there back into the main fluid reservoir, with fluid flow being created by the bubbles in the lift tube generated by the diffuser 005.2.

As fluid in the main fluid reservoir 001 is used, i.e., water from storage tank 001 is drawn off at out-flow 008 for use as household water, new water from an external source, such as a nearby well, can be added to the main fluid reservoir in a conventional fashion at in-flow 009.

Finally, to complement the ozone system, other conventional fluid reservoir accessories, such as fluid pumps, filters, fluid heaters, jets, and other equipment, may be employed. These accessories are all on a separate fluid line 007 and are used in a traditional manner. In some circumstances, it may be preferable for the ozone system and the accessories to share the same out-flow and in-flow holes in the pool or spa. This can be achieved with additional valves and tanks which would seek to emulate two separate lines with very different pressures involved. It may be preferable to operate the traditional fluid pump and filter system for longer periods than usual to prevent bacteria and algae growth in the fluid or filter system during periods of non-operation. The ozone system operates 24 hours a day and is used as an additional filtration system so that chemicals, salts, or other additives can be greatly reduced or even eliminated.

The ozone delivered to the main fluid reservoir 001 by the ozone treatment apparatus shown in FIG. 1 can be augmented by adding ozone to the reservoir through the use of a conventional ozone generator 006 and a venturi or static mixer 006.2 fed ozone via ozone line 006.1. The venturi or static mixer 006.2 can be positioned in the return pressure line 007.1 of the water pump (not shown) and would operate when the water pump and ozone generator 006 were both turned on.

The pool, spa, or storage tank 001 can be made of any shape and out of any number of traditional materials. However, the size of the pool, spa, or storage tank relates to the capacity of the ozone generator 005. Using an ozone generator 005 having an ozone generating capacity as above described, a pool will typically need one generator for approximately every 6,000 gallons of fluid. For a spa which is kept at higher temperatures, one generator would be appropriate for every 1200 gallons of fluid. Moreover, for pools and spas, the type of accessories, the fluid pump and filter systems used, the type of maintenance, and personal hygiene of the users would vary the amount of fluid that the ozone unit can keep clean. In addition, the pools and spas are preferably indoors or covered at all times with a cover when not in use, to reduce flying debris and impurities from being blown into the pool or spa.

The ozone generator preferably operates 24 hours a day. The ozone generator 005 typically uses about 200 Watts of electricity. Germs and spores are greatly reduced or even eliminated using the system disclosed in FIG. 1 without the use of any chemicals. Solids wastes, skin, hair and other impurities are continuously filtered from the fluid without use of additives or chemicals. The nitrogen cycle (nitrates, nitrites, and ammonia) seems to be disrupted and renders the fluid relatively pH stable. Algae growth in the pool or spa seems to be greatly reduced, requiring less cleaning cycles. The ozone produced by the UV lamps is so small that ozone can be injected into the fluid 24 hours a day without irritating the users or inhibiting any possible bio-film that may add to the treatment of the water. This continuous filtration and use of a small amount of ozone inhibits bacteria and algae growth in the pool or spa. Harmful levels of ozone gas do not irritate the skin, eyes, throat, nose, lungs or bronchial tubes because the ozone gas is located in a separate tank several feet away.

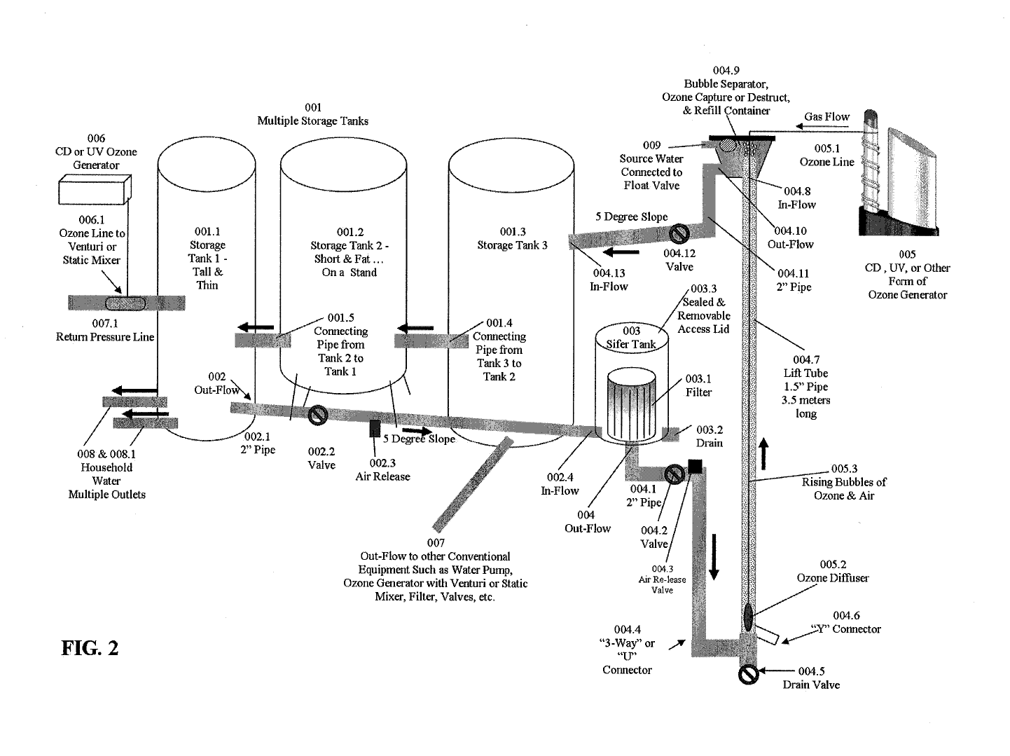

FIG. 2 illustrates a ground level side filter ozone water treatment system for a fluid reservoir comprising multiple fluid storage tanks according to one embodiment of the present invention. FIG. 2 shows that one ozone generator and treatment system according to the present invention can circulate and clean the fluid in multiple storage tanks, tanks 001.1, 001.2, and 001.3, connected in series. Previously, a site having two or more storage tanks required one ozone generator for each tank. If a given site had three tanks, it would require three ozone generators. Often, these installations only would have required one ozone generator taking into account the given the daily usage and flow rate, storage capacity of all the tanks combined, and the quality of the water source.

As seen in FIG. 2, the in-flow 004.13 of ozonated fluid from auxiliary reservoir 004.9 is first fed to storage tank 001.3. A connecting pipe 001.4 connects the fluid in storage tank 001.3 to the fluid in storage tank 001.2. Similarly, a connecting pipe 001.5 connects the fluid in storage tank 001.2 to the fluid in storage tank 001.1. Out-flow opening 002 is in storage tank 001.1 for allowing fluid flow into pipe 002.1 and thereby into side filter tank 003.

It is often the case that any given installation of multiple tanks, one will find a number of small tanks, some shorter or longer than others, and some mounted on legs, because each tank may have been made by a different manufacturer or purchased at different times. The multiple tank embodiment shown in FIG. 2 allows all types of tanks (short, tall, stout, and thin) to be combined into one larger virtual tank and to use only one ozone generator to treat the water stored in all of the tanks. The only limitation is that each tank's operating water level needs to be level with the other tanks (requiring some tanks to be put on stands so that when the tanks are full, the water level at rest would be approximately the same for every tank). Note also that it may be preferable that the connecting pipes between tanks have different entry angles and be positioned at different levels so that the ozonated water entering each tank swirls around and mixes better with the water already in the tank.

The fluid path for fluid in the ozone water treatment system shown in FIG. 2 is therefore from the multiple storage tanks 001 through filter 003.1, up the lift tube 004.7 and into the auxiliary fluid reservoir and from there back into the multiple storage tanks, with fluid flow being created by the bubbles in the lift tube generated by the diffuser 005.2.

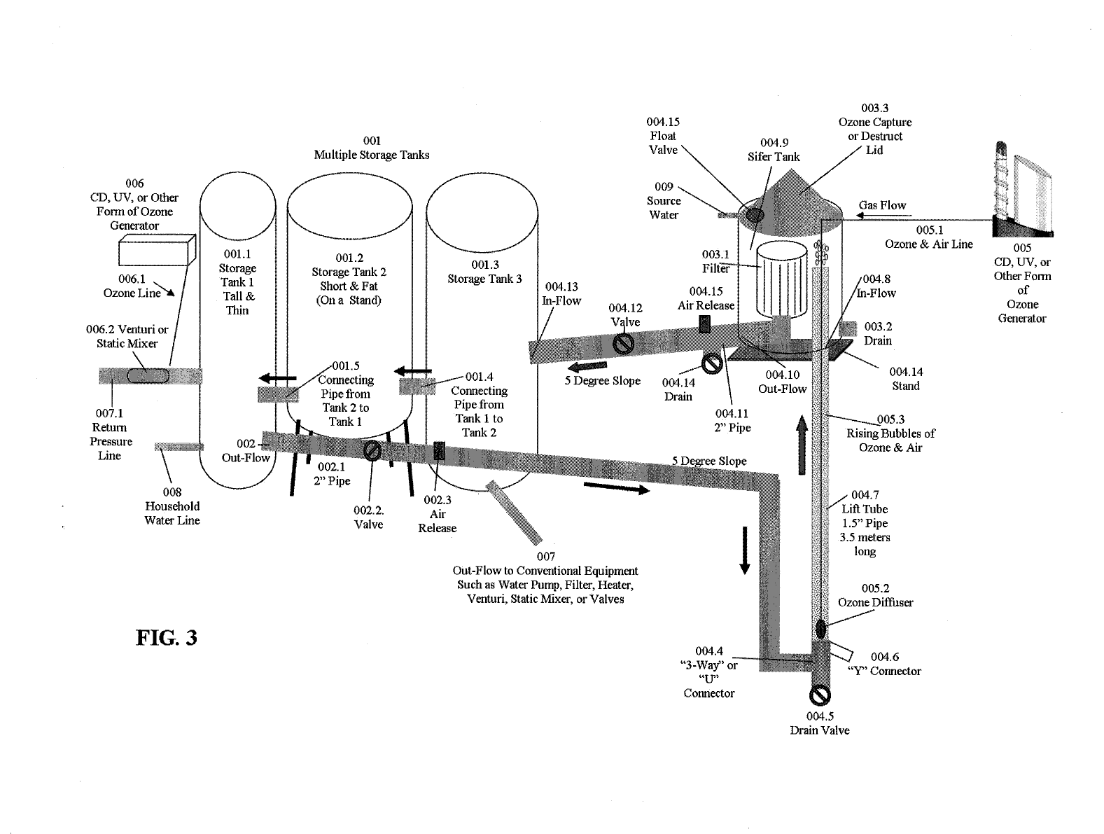

FIG. 3 illustrates a raised side filter ozone water treatment system for a water reservoir comprising multiple fluid storage tanks according to one embodiment of the present invention. As seen in FIG. 3, the side filter 003.1 is positioned inside auxiliary fluid reservoir 004.9 rather than in a separate side filter tank. The out-flow 004.10 is connected to the outlet of filter 003.1 In this embodiment, the ozonated water from lift tube 004.7 that flows into auxiliary fluid reservoir 004.9 flows through filter 003.1 and out the out-flow 004.10 into pipe 004.11 for return to storage tank 001.3. For the fluid in auxiliary reservoir 004.9 to flow by gravity back into storage tank 001.3, the auxiliary reservoir and filter 003.1 typically have to be mounted on a structure, e.g., a stand 004.14, that is several feet above the ground.

The fluid path for fluid in the ozone water treatment system shown in FIG. 3 is therefore from the multiple storage tanks 001 to and up the lift tube 004.7 into the auxiliary fluid reservoir where the fluid I s then filtered by filter 003.1 before the fluid flows back into the multiple storage tanks, with fluid flow being created by the bubbles in the lift tube generated by the diffuser 005.2.

One improvement of the system shown in FIG. 3 over the prior art is that untreated/dirty water is added at the auxiliary fluid reservoir 004.9, rather than directly into one of the main storage tanks. In the auxiliary fluid reservoir 004.9, the new water mixes with the ozonated water first and any impurities must pass through the filter 003.1 before the new water is allowed to flow into the main tank reservoir. As the water is circulated through the filter 003.1 in the auxiliary reservoir 004.9 and back to the main storage tanks over and over again, any remaining impurities are oxidized, flocculated, and otherwise trapped by the filter 003.1. As the water is removed from the main tank via the household water line 008, untreated new water is refilled directly to the auxiliary fluid reservoir.

The excess ozone that does not dissolve in the fluid in auxiliary fluid reservoir 004.9 can be collected using a semi-sealed ozone capture or destruct lid 003.3 positioned above the auxiliary fluid reservoir and either piped to another location or destroyed and changed back to oxygen by the use of activated carbon in a small outlet at the top of the lid or in some other way known in the art.

The auxiliary fluid reservoir 004.9 can also be used as a convenient method for adding fluid and keeping the level of the fluid in the main fluid reservoir at a constant level. Auxiliary fluid reservoir 004.9 can be fitted with a float valve 004.15 or alternatively a pressure switch to sense the fluid lever in the auxiliary fluid reservoir and thereby to keep the fluid level in the main fluid reservoir 001 at a constant level. New fluid from an external fluid source could then be caused to flow through a pipe or conduit 004.16 and into auxiliary reservoir 004.9 as a function of the operation of float valve 004.15. On the other hand, depending on the source fluid, the float valve or level switch may be fitted directly on the main fluid reservoir 001 but with the inflow of new fluid still being into auxiliary reservoir 004.9. This may be preferable when the source fluid is full of impurities which could dramatically clog filter 003.1 and thereby increase the fluid level in auxiliary fluid reservoir 004.9 while the fluid level in the main fluid reservoir 001 remains at a low level, because the flow rate of the fluid through the filter decreases to the point where in extreme cases, auxiliary fluid reservoir 004.9 would overflow, a good indication that it is time to clean the filter. The filter can be cleaned and reused by simply taking it off its mounted threads, or if conditions permit, keeping the filter attached, and cleaning it with a spray of fluid from a garden hose. The auxiliary fluid reservoir 004.9 can also be drained at valve 003.2 to remove any impurities that have settled to the bottom of the auxiliary reservoir.

Benefits of a Ground Level Side Filter Tank:

a) Eliminates the risk of one falling off the top of a raised auxiliary fluid reservoir while cleaning the filter or the diffuser stone;

b) Allows for a more convenient setup to clean the filter; i.e., this configuration eliminates the need to remove the filter from the Sifer tank because one could just spray the water on the pleats and let the water and debris drain out the bottom;

c) Allows for a more convenient setup to access and clean the diffuser stone because it is not inside the filter (one just has to pull the diffuser stone out of the lift tube), although one still needs to climb to the top of the water tank to gain access;

c) Eliminates debris falling into the main fluid reservoir during the process of cleaning the filter;

Benefits of a Raised Side Filter Tank:

a) Allows for water entering the storage tank to be pretreated with a concentrated dose of ozone in the auxiliary fluid reservoir;

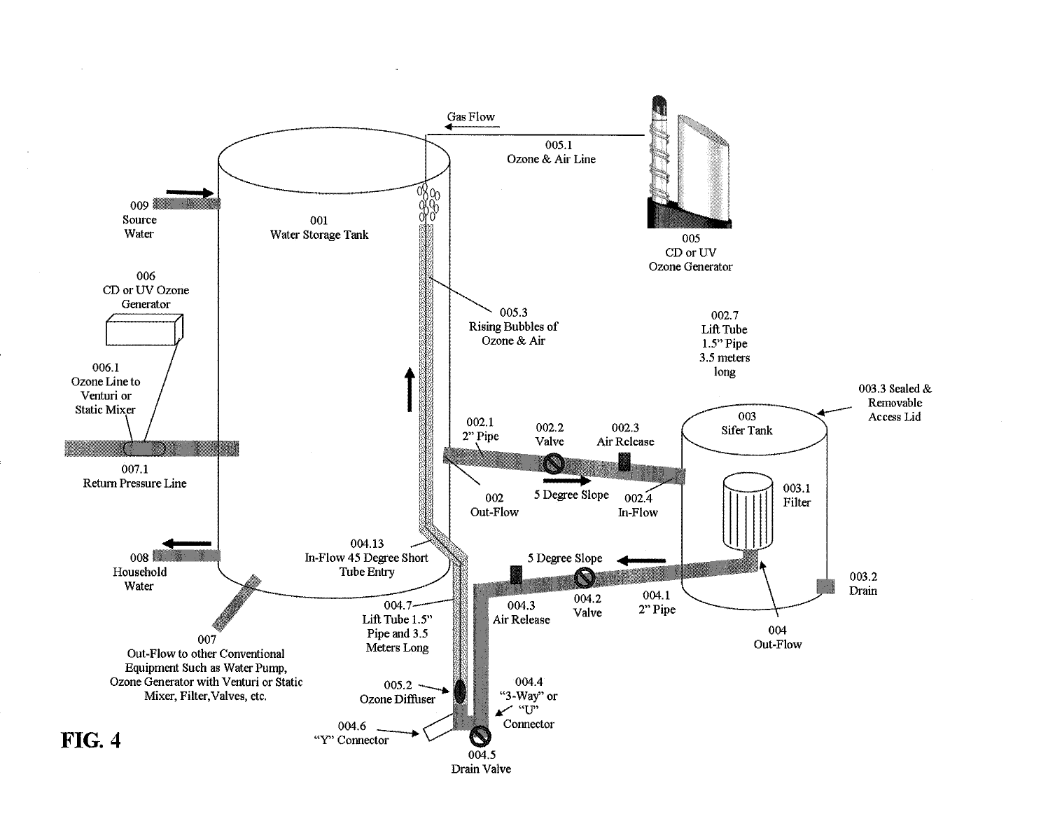

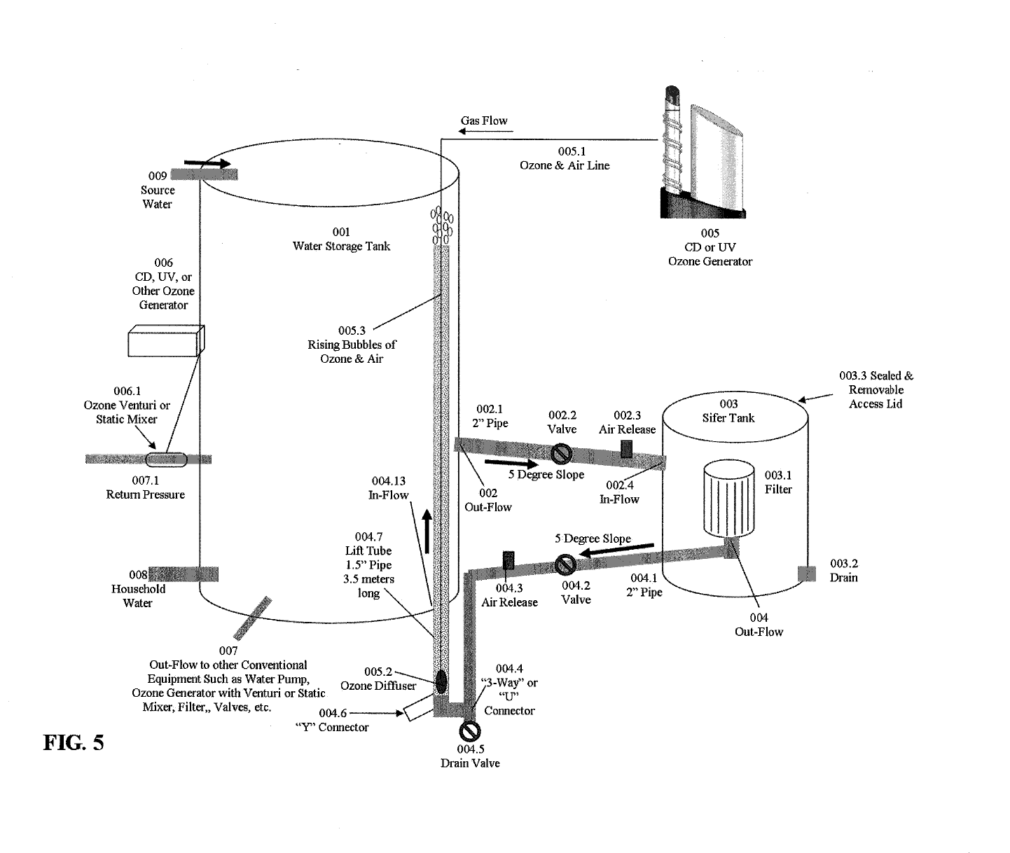

FIGS. 4 and 5 illustrates a ground level side filter ozone water treatment system for a water reservoir with the lift tube upper end positioned inside the water reservoir according to one embodiment of the present invention. As seen in FIG. 4, instead of there being a separate raised auxiliary fluid reservoir into which the top of the lift tube is inserted, in the illustrated embodiment, the top of the lift tube 004.7 is open within the main fluid reservoir 001. This configuration of lift tube 004.7 is most useful where the main fluid reservoir 001 is a storage tank, rather than a pool or spa, since one does not have to be concerned with a user being exposed to toxic ozone.

In FIG. 4, the lift tube enters the side of the storage tank 001 at a 45 degree angle, as seen at inflow 004.13. In FIG. 5, the lift tube 004.7 is straight along its entire length and enters the storage tank 001 at inflow 004.13 through the storage tank's bottom surface. Any angle of the lift tube causes the bubbles to coalesce and, depending on the angle, the bubbles can get much larger and generate popping sounds as they come to the surface. A small angle of short duration minimizes the time bubbles have to coalesce. On the other hand, connections such as unions, etc., would be cumbersome, but could work, if one wanted to have a completely straight lift tube under a tank.

The fluid path for fluid in the ozone water treatment system shown in FIGS. 4 and 5 is therefore from the main fluid reservoir 001 through filter 003.1, up the lift tube 004.7 and back into the main fluid reservoir 001, with fluid flow being created by the bubbles in the lift tube generated by the diffuser 005.2.

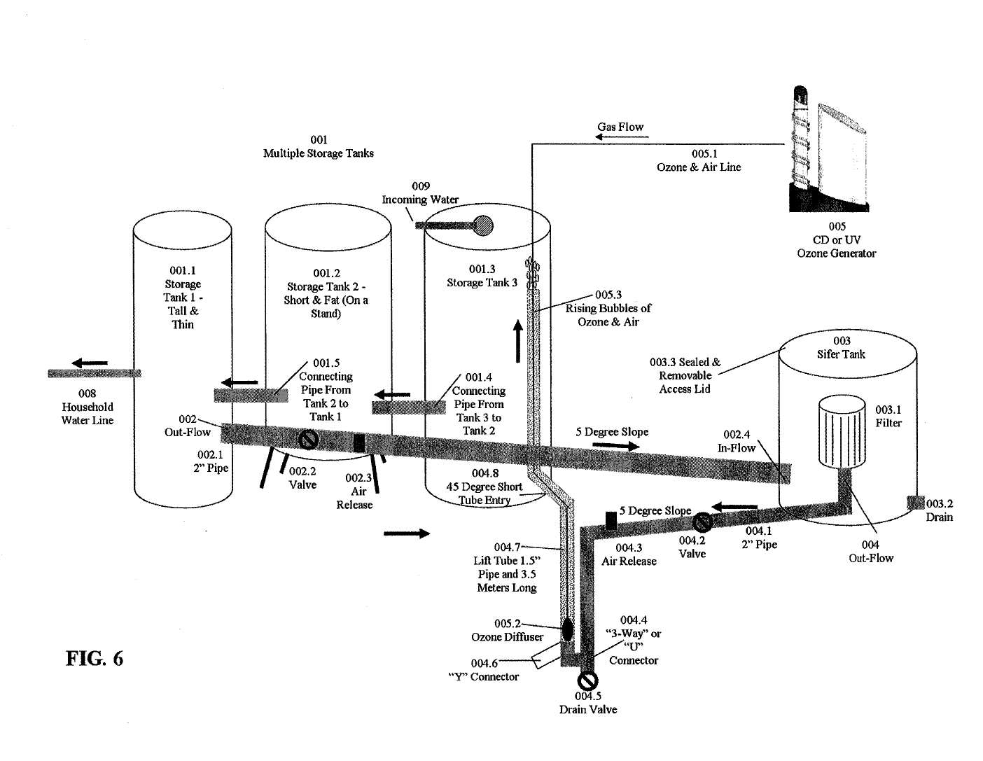

FIG. 6 illustrates a ground level side filter ozone water treatment system for a fluid reservoir comprising multiple fluid storage tanks with the lift tube upper end positioned inside one of the water tanks according to one embodiment of the present invention. As seen in FIG. 6, the lift tube 004.7 is positioned so that its upper end is open in storage tank 001.3. Similar to the operation of the multiple storage tanks in the embodiments shown in FIGS. 2 and 3, the fluid flow is from storage tank 001.3 to storage tank 001.2 and to storage tank 001.1 in series, with fluid flow out of storage tank 001.1 via outflow 002 to the side filter tank 003.

FIG. 7 illustrates a side-filter ozone water treatment system for a fluid reservoir comprising multiple fluid storage tanks mounted on the roof of a building or the like according to one embodiment of the present invention. As seen in FIG. 7, a roof mounted treatment system containing multiple storage tanks enables the lift tube 004.7 to be conveniently mounted down along the surface of the building below the level of the roof, and enables the side filter tank 003 to be mounted on the surface of the roof.

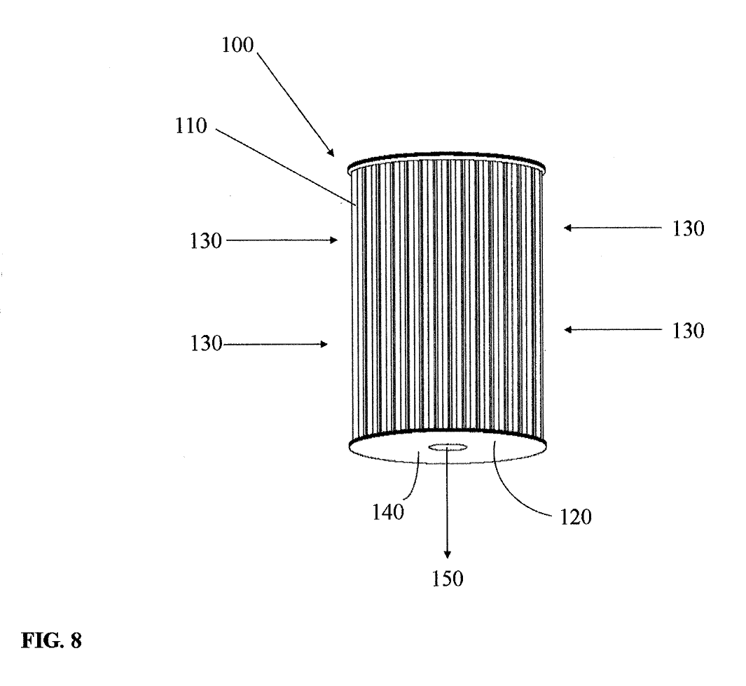

FIG. 8 is an exemplary filter cartridge for use as a fluid filter according to one embodiment of the present invention. As seen in FIG. 8, a conventional fluid filter cartridge 100 can be used to provide the filtering needed by the embodiments of the invention. A preferred filter media is Reemay formed in pleats 110 mounted around a cylindrical core 120. Fluid flow preferably is shown with flow into the filter through the pleats at 130 and out of the bottom 140 of the filter's cylindrical core 120 at 150.

The foregoing descriptions of various specific embodiments in accordance with the invention have been presented for purposes of illustration and description. They are not intended to be exhaustive or to limit the invention to the precise forms disclosed, and many modifications and variations are possible in light of the above teaching. The invention is to be construed according to the claims and their equivalents.

What is claimed is:

1. An apparatus for ozone-aerating and filtering fluid in a main fluid reservoir, comprising:
an auxiliary fluid reservoir positioned adjacent to and outside of the main fluid reservoir;
a lift tube positioned outside of the main fluid reservoir and having an upper end and a lower end, said lift tube upper end open within the auxiliary fluid reservoir, said lift tube extending below the auxiliary fluid reservoir a predetermined length;
a first conduit for enabling fluid in the auxiliary fluid reservoir to flow into the main fluid reservoir;
a second conduit for enabling fluid to flow by gravity from the main fluid reservoir into the lower end of said lift tube;
a diffuser positioned inside said lift tube at its lower end for injecting ozonated air into the fluid in said lift tube, such that, when ozonated air is injected into said lift tube by the diffuser, the ozonated air comes into contact with the fluid in said lift tube and ozone-aerates said fluid, and wherein the expansion of the ozonated air as it bubbles up said lift tube causes fluid in said lift tube to flow up said lift tube and into the auxiliary fluid reservoir, which causes the level of fluid in the auxiliary fluid reservoir to rise higher than the level of fluid in the main fluid reservoir, and thereby cause ozone-aerated fluid in the auxiliary fluid reservoir to flow by gravity into the first fluid conduit and into the main fluid reservoir at the same time causing fluid to be drawn through said second fluid conduit from the main fluid reservoir and into said lift tube; and
a fluid filter positioned outside of the main reservoir and in the fluid path formed by said first and second fluid conduits, said lift tube, and said auxiliary fluid reservoir for filtering the fluid flowing therein.

2. The apparatus of claim 1, wherein said fluid filter is positioned inside said auxiliary fluid reservoir such that ozonated fluid is filtered before entering said first conduit.

3. The apparatus of claim 1, wherein said fluid filter is positioned in a third fluid reservoir connected along said second conduit, such that fluid flowing in said second conduit is filtered by said fluid filter before the fluid reaches the lower end of said lift tube.

4. The apparatus of claim 3, wherein said third fluid reservoir is positioned at ground level.

5. The apparatus of claim 1, wherein the main fluid reservoir comprises a plurality of water tanks each connected to the others in series by respective tank fluid conduits, and wherein said first fluid conduit is connected to the first water tank of said series of water tanks, and said second fluid conduit is connected to the last water tank of said series of water tanks, such that ozonated fluid is caused to flow from said first conduit into the first of said plurality of reservoirs, through each of the other water tanks in said series of water tanks and out through the second fluid conduit.

6. The apparatus of claim 1, further comprising:
a float valve positioned in said auxiliary fluid reservoir for sensing when the fluid level in said auxiliary fluid reservoir drops below a predetermined level; and
a third conduit connected between said float valve and an external fluid source to enable fluid to be added to said auxiliary fluid reservoir in response to said sensing.

7. The apparatus of claim 1, wherein said lift tube is at least ten feet long and has a diameter of between about one and one half inches and two inches.

8. The apparatus of claim 1, wherein the second conduit has a slope of at least 5 degrees down from the main fluid reservoir to the lower end of the lift tube, and wherein the first conduit has a slope of at least 5 degrees down in the direction from the auxiliary fluid reservoir to the main fluid reservoir.

9. The apparatus of claim 1, further comprising an ozone-capturing device positioned above the auxiliary fluid reservoir for capturing undissolved excess ozone gas.

10. The apparatus of claim 1, wherein filtering surfaces of the filtration device supports a filtering layer of bio-film comprising organic material.

11. The apparatus of claim 2, wherein the auxiliary fluid reservoir has a bottom and wherein said first conduit is connected to said fluid filter at the bottom of said auxiliary fluid reservoir.

12. The apparatus of claim 2, wherein the apparatus further comprises:
an out-flow valve to control the flow of ozone-aerated fluid from the auxiliary fluid reservoir to the main fluid reservoir;
an in-flow valve to control the flow of fluid from the main fluid reservoir to the auxiliary fluid reservoir; and
a drainage valve coupled to the lower portion of the auxiliary fluid reservoir for enabling drainage of the fluid in the auxiliary fluid reservoir when the drainage valve is open, such that, when the in-flow valve and the out-flow valves are closed, the fluid filter and the auxiliary fluid reservoir can be cleaned without contaminating the fluid in the main fluid reservoir.

13. The apparatus of claim 3, wherein the apparatus further comprises:
an in-flow valve to control the flow of fluid from the main fluid reservoir to said third fluid reservoir;
an out-flow valve to control the flow of fluid from said third fluid reservoir to the lower end of said lift tube; and
a drainage valve coupled to the lower portion of said third fluid reservoir for enabling drainage of fluid in the third fluid reservoir when the drainage valve is open, such that, when the in-flow valve and the out-flow valves are closed, the fluid filter and the third fluid reservoir can be cleaned without contaminating the fluid in the main fluid reservoir.

14. An apparatus for ozone-aerating and filtering fluid in a main fluid reservoir, comprising:
an auxiliary fluid reservoir positioned adjacent to and outside of the main fluid reservoir;
a first conduit for enabling fluid to flow by gravity from the main fluid reservoir into the auxiliary fluid reservoir;
a fluid filter housed within the auxiliary fluid reservoir;
a lift tube having an upper end and a lower end, the upper end of said lift tube open within the main fluid reservoir, said lift tube extending below the main fluid reservoir a predetermined length;
a second conduit for enabling fluid to flow by gravity from the auxiliary fluid reservoir into the lower end of said lift tube; and
a diffuser positioned inside said lift tube at its lower end for injecting ozonated air into the fluid in said lift tube, such that, when ozonated air is injected into said lift tube by the diffuser, the ozonated air comes into contact with the fluid in said lift tube and ozone-aerates said fluid, and wherein the expansion of the ozonated air as it bubbles up said lift tube causes the fluid in said lift tube to flow up said lift tube and into the main fluid reservoir, such that fluid is caused to flow by gravity into and through the first fluid conduit from the main fluid reservoir into the auxiliary fluid reservoir, through said filter, into and through said second fluid conduit, and into the lower end of said lift tube.

15. The apparatus of claim 14, wherein the main fluid reservoir has a bottom surface and wherein the lift tube is positioned to extend into the main fluid reservoir through said bottom surface.

16. The apparatus of claim 14, wherein the main fluid reservoir has a bottom surface and at least one side surface extending from said bottom surface to define a fluid container, and wherein the lift tube is positioned to extend into the main fluid reservoir through said side surface.

17. The apparatus of claim 16, wherein the lift tube enters the main fluid reservoir at an angle that minimizes the generation of large ozone bubbles in the fluid inside the lift tube.

18. The apparatus of claim 17, wherein said lift tube angle at the point where said lift tube enters the main fluid reservoir is 45 degrees.

19. The apparatus of claim 14, wherein the main fluid reservoir comprises a plurality of water tanks each connected to the others in series by respective tank fluid conduits, and wherein said lift tube opens into the first water tank of said series of water tanks, and said first fluid conduit is connected to the last water tank of said series of water tanks, such that ozonated fluid is caused to flow from said first of said plurality of water tanks, through each of the other water tanks in said series of water tanks and out through the first fluid conduit.

20. The apparatus of claim 19, wherein said lift tube is at least ten feet long and has a diameter of between about one and one half inches and two inches.

21. The apparatus of claim 19, further comprising:
an in-flow valve to control the flow of fluid from the last water tank of said series of water tanks to said auxiliary fluid reservoir;
an out-flow valve to control the flow of fluid from said auxiliary fluid reservoir to the lower end of said lift tube; and
a drainage valve coupled to the lower portion of said auxiliary fluid reservoir for enabling drainage of fluid in the auxiliary fluid reservoir when the drainage valve is open, such that, when the in-flow valve and the out-flow valves are closed, the filter and the auxiliary fluid reservoir can be cleaned without contaminating the fluid in the plurality of water tanks.
